(19) United States
(12) Patent Application Publication
(10) Pub. No.: US 2020/0103520 A1
(43) Pub. Date: Apr. 2, 2020

(54) APPARATUS AND METHODS FOR A SYNTHETIC APERTURE RADAR WITH MULTI-APERTURE ANTENNA

(71) Applicants: Urthecast Corp, Vancouver (CA); King Abdullah City of Science and Technology, Riyadh (SA)

(72) Inventors: Peter Allen Fox, Burnaby (CA); Stephen Richard Lilley, Vancouver (CA)

(21) Appl. No.: 16/616,362

(22) PCT Filed: May 23, 2018
(86) PCT No.: PCT/US2018/034144

§ 371 Date: Nov. 22, 2019

Related U.S. Application Data
(60) Provisional application No. 62/510,182, filed on May 23, 2017.

(51) Int. Cl. G01S 13/90

(52) U.S. Cl. CPC G01S 13/9052

(57) ABSTRACT

A Spotlight SAR imaging mode is implemented by a synthetic aperture radar (SAR) system in which an SAR controller intentionally spoils a transmit beam of the SAR antenna to form a spoiled transmit beam. The SAR system transmits pulses using the spoiled transmit beam, divides the SAR antenna into a plurality of azimuth apertures, receives received pulses by the SAR antenna using a number M of multiple receive beams, processes data received by each of the number M of multiple receive beams to generate a number M of sub-images by the SAR processor; and coherently combines two or more of the number M of sub-images to form a Spotlight image. Thus, a multi-aperture antenna comprises multiple azimuth apertures (i.e., a sub apertures), each formed from one or more azimuth phase centers. The sub-apertures can be independent from one another. The sub-apertures can keep a target illuminated by the beam for a longer time than conventional Stripmap mode, for example. The sub-apertures can be combined in processing to form a high resolution image, with high image quality.

### TECHNICAL FIELD

The present application relates generally to a synthetic aperture radar (SAR) and, more particularly, to a SAR having a multi-aperture antenna operating in a Spotlight imaging mode.

### BACKGROUND

### Description of the Related Art

### Synthetic Aperture Radar (SAR)

Synthetic aperture radar (SAR) is an imaging radar capable of generating finer spatial resolution than conventional beam-scanning radar. A SAR is typically mounted on an airborne or spaceborne platform and designed to acquire images of a terrain such as the Earth or other planets.

A single frequency SAR generates images of the terrain by transmitting radar pulses in a frequency band centered on a single frequency. For example, in the case of the RADARSAT-2 SAR, the center frequency was 5.405 GHz. A dual-band SAR can operate in two frequency bands. For example, a dual-band SAR can operate at L-band (1 GHz to 2 GHz) and X-band (8 GHz to 12 GHz). A multi-band SAR can operate in two or more frequency bands.

Some existing SAR systems, such as the Shuttle Imaging Radar SIR-C, can operate at more than one frequency band using separate apertures. Others can operate using a shared aperture. A phased array antenna with steering in both planes can be included in an implementation of a dual-band shared-aperture single-polarization or multi-polarization SAR. A phased array antenna comprises an array of constituent antennas or radiating elements. Each radiating element can be fed by a signal whose phase and amplitude, relative to the phase and amplitude of the signal fed to the other radiating elements, can be adjusted so as to generate a desired radiation pattern for the phased array antenna.

It can be desirable for a SAR to be capable of imaging at different polarizations (for example, single polarization and multi-polarization such as quad-polarization), and in different operational modes such as ScanSAR and spotlight SAR.

Spotlight SAR is an operational mode of a SAR in which high-resolution images can be generated by steering the radar beam to keep the target within the beam for a longer time than, for example, conventional Stripmap mode, and thereby forming a longer synthetic aperture. Beam steering can be achieved, for example, by electronic beam steering. Typically, the higher resolution available in Spotlight SAR operation of a SAR is achieved at the expense of swath width (spatial coverage). For a more detailed description of SAR operating modes, see for example Moreira A., et al., “A Tutorial on Synthetic Aperture Radar”, IEEE Geoscience and Remote Sensing Magazine (March 2013).

Benefits of a phased array antenna can include flexibility in defining operational modes, reduced power density, redundancy, use of vertical beam steering for ScanSAR, zero Doppler (azimuth) steering and use of vertical beamwidth and shape control for single-beam and/or ScanSAR swath width control.

### BRIEF SUMMARY

A method of operation of a synthetic aperture radar (SAR) system comprising a SAR antenna, a SAR processor, and a SAR controller may be summarized as including entering a Spotlight SAR imaging mode by the SAR controller; spoiling a transmit beam of the SAR antenna to form a spoiled transmit beam; transmitting a plurality of transmitted pulses by the SAR antenna using the spoiled transmit beam; dividing the SAR antenna into a plurality of azimuth apertures by the SAR controller; receiving a plurality of backscattered pulses by the SAR antenna using a number M of multiple receive beams, each of the plurality of backscattered pulses corresponding to a respective one of the plurality of transmitted pulses; processing data received by each of the number M of multiple receive beams to generate a number M of sub-images by the SAR processor; and coherently combining two or more of the number M of sub-images to form a Spotlight image.

The method may further include compressing data from the number M of multiple receive beams by the SAR processor. Compressing data from the number M of multiple receive beams by the SAR processor may include performing a Block Adaptive Quantization (BAQ) to 4 bits. Receiving a plurality of received pulses by the SAR antenna using a number M of multiple receive beams may include receiving a plurality of received pulses by a planar phased array. Receiving a plurality of received pulses by a planar phased array may include receiving a plurality of received pulses by a planar phase array including a plurality of antenna phase centers. Receiving a plurality of received pulses by the SAR antenna using a number M of multiple receive beams may include receiving a plurality of received pulses by a dual-band antenna. Receiving a plurality of received pulses by a dual-band antenna may include receiving a plurality of received pulses by at least one of an X-band or an L-band antenna. Processing data received by each of the number M of multiple receive beams to generate a number M of sub-images by the SAR processor may include processing data received by each of the number M of multiple receive beams to generate a number M of sub-images by the SAR processor on-board one of a satellite, a spacecraft, and a space station.

The method may further include downlinking one or more of the number M of sub-images by a communications antenna to a ground terminal. Coherently combining two or more of the number M of sub-images to form a Spotlight image may include coherently combining two or more of the number M of sub-images to form a Spotlight image on-board one of a satellite, a spacecraft, and a space station.

The method may further include downlinking the Spotlight image by a communications antenna to a ground terminal. Spoiling a transmit beam of the SAR antenna to form a spoiled transmit beam may include broadening a transmit beam of the SAR antenna to form a spoiled transmit beam. Spoiling a transmit beam of the SAR antenna to form a spoiled transmit beam may include applying a phase shift to an antenna panel of the SAR antenna.

A method of operation of a synthetic aperture radar (SAR) system comprising a SAR antenna, a SAR processor, and a SAR controller may be summarized as including entering a Spotlight SAR imaging mode by the SAR controller; transmitting a plurality of transmitted pulses by the SAR antenna using a transmit beam; dividing the SAR antenna into a plurality of azimuth apertures by the SAR controller; spoiling a number M of multiple receive beams; receiving a plurality of backscattered pulses by the SAR antenna using the number M of multiple receive beams, each of the plurality of backscattered pulses corresponding to a respective one of the plurality of transmitted pulses; processing data received by each of the number M of multiple receive beams to generate a number M of sub-images by the SAR processor; and coherently combining two or more of the number M of sub-images to form a Spotlight image,

A SAR system comprising a SAR antenna, a SAR processor, a SAR controller, and a communications antenna, the system may be selectively operable to perform the method. The SAR antenna may be a spaceborne SAR antenna. The SAR processor and the SAR controller may be co-hosted with the spaceborne SAR antenna on one of a satellite, a spacecraft, and a space station. The SAR antenna may include a plurality of antenna panels, the SAR system operable to apply to each of the plurality of antenna panels a respective phase shift, the respective phase shift selected to cause a broadening of a beam of the SAR antenna.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram illustrating a portion of a four-panel dual-band SAR antenna, in accordance with systems and methods of the present application.

FIG. 2A is a graph illustrating an example antenna pattern for a four-panel antenna at a steering angle of 0°.

FIG. 2B is a graph 200b illustrating an example antenna pattern for a four-panel antenna at a steering angle of 0.3°.

FIG. 3A is a graph illustrating an example antenna pattern for a six-panel antenna at a steering angle of 0°.

FIG. 3B is a graph illustrating an example antenna pattern for a six-panel antenna at a steering angle of 0.3°.

FIG. 4A is a graph illustrating an example antenna pattern for a six-panel antenna with beam-spoiling at a steering angle of 0°.

FIG. 4B is a graph illustrating an example antenna pattern for a six-panel antenna with beam-spoiling at a steering angle of 0.3°.

FIG. 5A is a graph that shows exemplary impulse responses for point targets at a center of a swath.

FIG. 5B is a graph that shows exemplary impulse responses for point targets at an edge of the swath.

FIG. 5C is a graph that shows an estimated NESZ across a swath.

FIG. 6 is a plot of an estimated NESZ for an exemplary scenario which includes intentionally spoiling an antenna beam.

FIG. 7 is a plot that shows an estimated NESZ across a Spotlight swath for transmit spoiling and multiple sub-apertures on receive.

FIG. 8 is a flow chart showing an exemplary method of multi-aperture Spotlight mode operation of a SAR, in accordance with the systems and methods described in the present application.

FIG. 9 is a block diagram of a SAR system, in accordance with the systems and methods of the present application.

FIG. 10 is an isometric via of a SAR antenna in the form of a planar phased array antenna assembly, in accordance with the systems and methods described in the present application.

### DETAILED DESCRIPTION

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one implementation” or “an implementation” or “one embodiment” or “an embodiment” means that a particular feature, structure or characteristic described in connection with the implementation or embodiment is included in at least one implementation or at least one embodiment. Thus, the appearances of the phrases “one implementation” or “an implementation” or “in one embodiment” or “in an embodiment” in various places throughout this specification are not necessarily all referring to the same implementation or the same embodiment. Furthermore, the particular features, structures, or characteristics may be combined in any suitable manner in one or more implementations or one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The Abstract of the Disclosure provided herein is for convenience only and does not interpret the scope or meaning of the embodiments.

### Phased Array SAR Antenna

A phased array SAR antenna can have one or more azimuth phase centers, located on one or more panels of the antenna. The azimuth phase centers can be used to form multiple independent azimuth apertures, or can be combined to form a single aperture. In some implementations, the number of independent azimuth apertures is the same as the number of azimuth phase centers. In other implementations, the number of independent azimuth apertures is different from the number of azimuth phase centers. Independent control of the azimuth phase centers can enable azimuth beam-shaping and beam-steering.

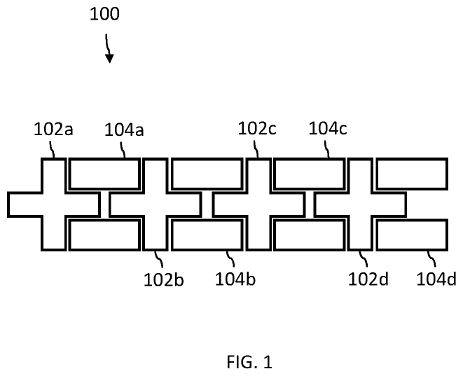

In one implementation of a SAR, the SAR antenna includes two or more antenna panels, and the SAR can have independent control of each antenna panel. Independent control of each antenna panel enables azimuth beam shaping and azimuth beam steering. SAR data can be received from each antenna panel independently, and antenna receive beams can be formed after data acquisition by a processor on-board the SAR platform or on the ground. An antenna as described in this paragraph is referred to in the present application as a multi-aperture antenna. In one implementation, a multi-aperture antenna can be a multi-aperture antenna of a dual-band SAR. See, for example, FIG. 1 and its accompanying description.

Typically, SpotSAR mode (also referred to in the present application as Spotlight SAR mode and also as Spotlight SAR imaging mode) uses electronic beam steering in azimuth on both transmit and receive to maintain a continuous illumination of a desired image area on the ground during data acquisition. Continuous illumination can increase the dwell time on a target in the image area, and can improve the along-track resolution of the target in the image.

Conventionally, a SAR in Spotlight mode can use multiple azimuth phase centers to steer the beam, and can combine the multiple azimuth phase centers into a single aperture. The present application describes systems and methods for forming a multi-aperture antenna comprising multiple azimuth apertures (i.e., a sub-apertures), each formed from one or more azimuth phase centers. The sub-apertures can be independent from one another. The sub-apertures can keep a target illuminated by the beam for a longer time than conventional Stripmap mode, for example. The sub-apertures can be combined in processing to form a high resolution image, with high image quality.

Azimuth steering angle may be constrained by desired image quality. As the beam is steered away from an angle broadside to the along-track direction, grating lobes can appear in the antenna beam pattern. The grating lobes can affect image quality.

In one implementation, a multi-aperture antenna uses four panels. In another implementation, a multi-aperture antenna uses six panels. A six-panel antenna may have improved multi-aperture capability over a four-panel antenna. Improved multi-aperture capability can lead to improved performance of the SAR in a Spotlight imaging mode.

Noise Equivalent Sigma Zero (NESZ) is measure of sensitivity of the system to areas of low backscatter, and can represent a backscatter coefficient corresponding to a Signal to Noise Ratio (SNR) of unity. For given transmitted power, NESZ can depend at least in part on antenna area.

In some implementations, the antenna beam in azimuth is spoiled to achieve a wider along-track swath for a Spotlight imaging mode. Though, spoiling the antenna beam in azimuth can increase the image swath in Spotlight mode, spoiling the antenna beam in azimuth can adversely affect the antenna gain and NESZ.

It can be beneficial to use multi-aperture capability and antenna beam design to improve performance of a SAR, and to generate high-resolution Spotlight imagery, such as 1 m resolution imagery at X-band using a multi-aperture SAR antenna.

The present application describes systems and methods for use of multiple apertures or sub-apertures, each sub-aperture sampled independently of each other, and combined during processing to increase image swath in a Spotlight imaging mode. The presently described approach can overcome a shortcoming of using a spoiled beam on receive, the use of which can adversely affect image quality.

### Spotlight Imaging Mode (SpotSAR)

In one example implementation of a SAR operable in a Spotlight imaging mode, the SAR is an X-band SAR. In other implementations, the SAR is a dual-band or multi-band SAR. In a dual-band SAR, the antenna arrays for both bands may share the same aperture. The SAR can be a single-polarization SAR or a multi-polarization SAR.

The size of the antenna in the along-track (or horizontal) dimension can limit the achievable along-track (or azimuth) resolution in a Stripmap SAR imaging mode, with the relationship between resolution (ρ) and aperture dimension (A) being given by:

$$ρ = k \frac{A}{2}$$

where k is a broadening factor inherent in the design for suppression of the processing sidelobes of a SAR image. A typical value of k is 1.2. For an aperture dimension of 6 m, the achievable along-track resolution is 3 m for k=1.0, and 3.6 m for k=1.2. The achievable resolution is independent of radar frequency.

In a Spotlight imaging mode, the antenna beam pointing is adjusted in azimuth to maintain continuous illumination of the target (spot) on the ground during data acquisition. The achievable resolution then becomes a function of the duration of the illumination, as follows:

$$ρ = k * \frac{R * λ}{2 * V * δ t}$$

where R is the range to the target (m), λ is the radar wavelength (m), V is the velocity of the SAR platform (m/s), and δt is the duration of the illumination (s).

In a Spotlight imaging mode, the duration of the illumination is given by:

$$δ t = \frac{R * δθ}{V}$$

where δθ is the extent of the antenna azimuth scanning (rad) during the illumination of the target.

The achievable azimuth resolution in a Spotlight imaging mode is therefore given by:

$$ρ = k * \frac{λ}{2 * δθ}$$

### Example SAR Antenna Implementation

As described previously, one implementation of a SAR antenna can have multiple panels, each panel including a number of rows of transmit/receive elements. FIG. 1 is a schematic diagram illustrating a portion of a SAR antenna 100, in accordance with systems and methods of the present application. FIG. 1 shows a portion of one row of one panel. In the example shown in FIG. 1, SAR antenna 100 is a dual-band SAR antenna, and SAR antenna 100 comprises L-band elements 102a, 102b, 102c, and 102d, and X-band elements 104a, 104b, 104c, and 104d.

In other implementations, a SAR antenna with multiple panels can be a single-band antenna, a multi-band antenna, or a dual-band antenna operable at a different frequency band combination from L-band and X-band.

In one implementation, the SAR antenna has six phase centers in azimuth. The SAR antenna can be hosted on a SAR platform. The SAR platform can be a spaceborne platform (for example, a free-flying spacecraft, satellite, or space station) or an airborne platform (for example, an aircraft, unmanned aircraft, or drone). As described above, a six-phase-center antenna may provide benefits in terms of multi-aperture capability (over a four-phase-center antenna, for example), and, at least partly in consequence, improved SpotSAR performance.

Each antenna azimuth aperture (i.e., sub-aperture) can be driven by an independent set of sensor electronics, and can be controlled independently in both phase and amplitude. Data received from each panel can be recorded independently, and processed independently.

The antenna can perform electronic beam steering in azimuth, by offsetting the phase of each phase center relative to the other phase centers by applying a linear phase ramp across phase centers. The phase offset (φₙ) of a given phase center to steer the beam to angle θ is given by:

$${ϕ}_{n} = \frac{{a}_{n} * sin θ}{λ}$$

where aₙ=(n−0.5*(N+1))*A, A is a horizontal dimension of the antenna associated with the given phase center, N is the number of phase centers (N=6 in this case), λ is the wavelength at which the antenna is operating, and n is an integer index assigned to each phase center (1≤n≤6 in this case).

The antenna beam pattern of each antenna phase center can limit steering, and each phase center has a beam width given by:

$${θ}_{p} = \frac{λ}{A}$$

As the beam is steered to this angle or beyond, grating side-lobes in the beam can start to appear. These grating side-lobes can have an adverse effect on image quality, as measured by an Azimuth Ambiguity Ratio (AAR).

A smaller sub-aperture (associated with one or more constituent azimuth phase centers) can provide a wider beam width. A wider beam width can provide a larger steering angle, and can support improved along-track resolution and higher image quality.

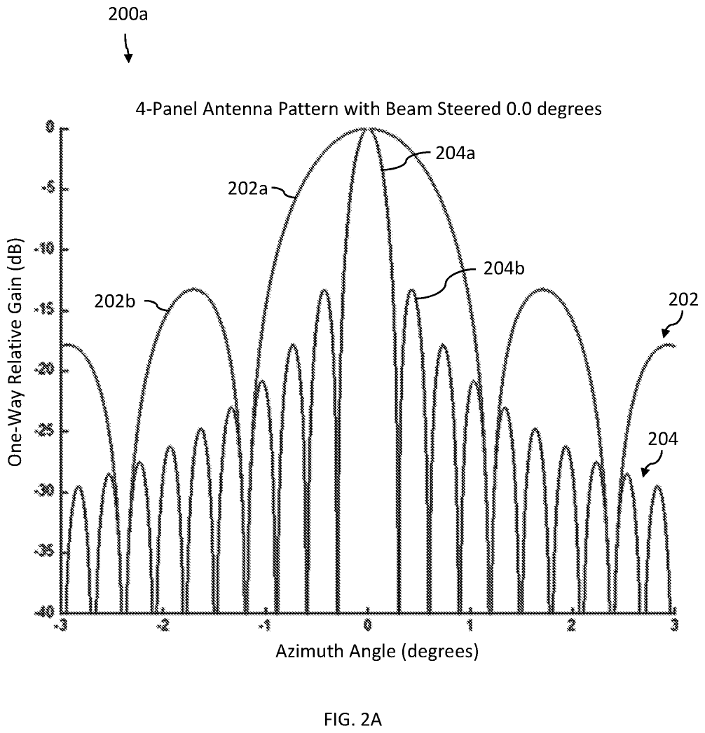

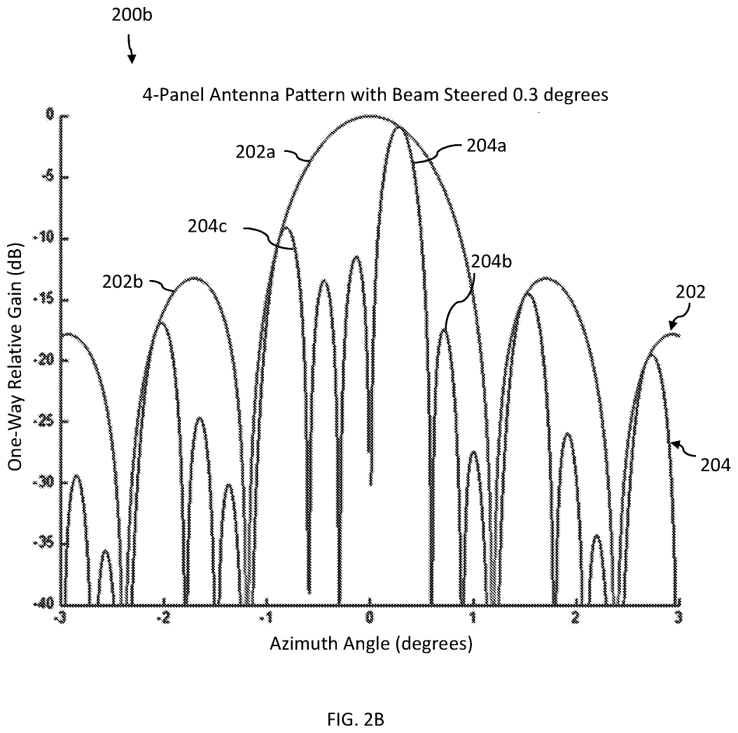

FIGS. 2A, 2B, 3A, 3B, 4A, and 4B show antenna patterns for an example antenna implementation having one azimuth phase center per panel, and one azimuth phase center per azimuth aperture. In other implementations, there need not be a one-to-one relationship between the number of azimuth phase centers and the number of panels, or between the number of azimuth phase centers and azimuth apertures.

FIG. 2A is a graph 200a illustrating an example antenna pattern for a four-panel antenna at a steering angle of 0°. FIG. 2A includes a plot 202 of an antenna pattern for a single panel with main lobe 202a and first side-lobe 202b. FIG. 2A includes a plot 204 of an antenna pattern for a four-panel antenna with main lobe 204a and first side-lobe 204b.

FIG. 2B is a graph 200b illustrating an example antenna pattern for a four-panel antenna at a steering angle of 0.3°. FIG. 2B includes a plot 202 of an antenna pattern for a single panel with main lobe 202a and first side-lobe 202b.

FIG. 2B includes a plot 204 of an antenna pattern for a four-panel antenna with main lobe 204a and first side-lobe 204b. Plot 204 includes a grating side-lobe 204c (only one grating side-lobe called out in FIG. 2B). Grating side-lobe 204c is significant relative to main lobe 204a even at a steering angle of 0.3°. For example, in plot 200b, grating side-lobe 204c is within 10 dB of main lobe 204a. At higher steering angles, the amplitude of grating side-lobe 204c can exceed the amplitude of main lobe 204a. Grating side-lobe 204c can adversely affect image quality.

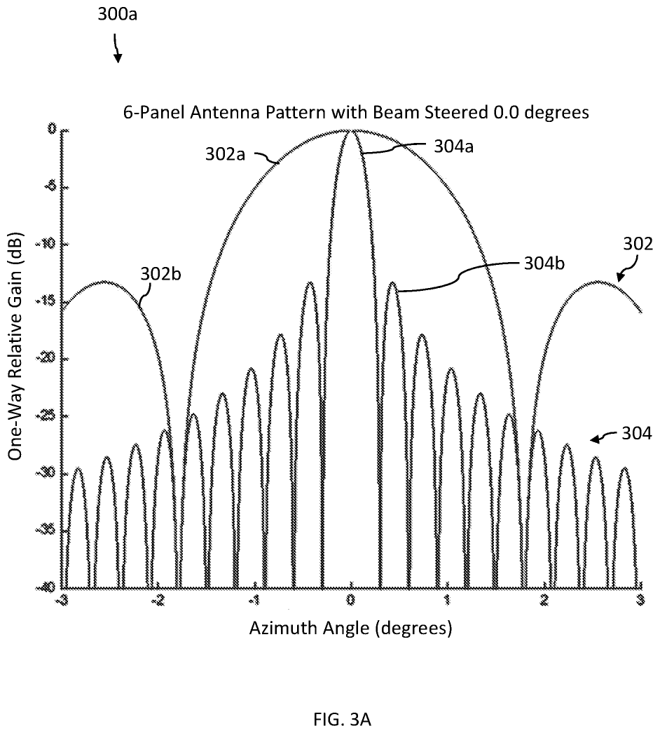

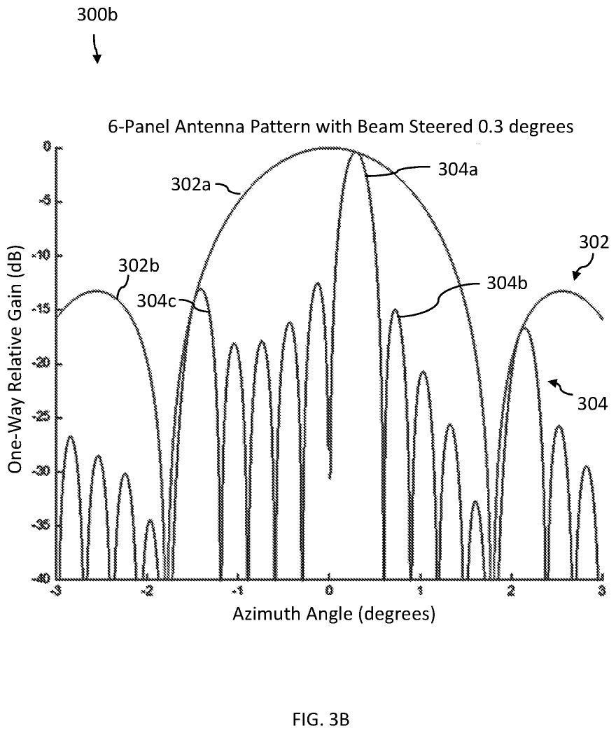

FIG. 3A is a graph 300a illustrating an example antenna pattern for a six-panel antenna at a steering angle of 0°. FIG. 3A includes a plot 302 of an antenna pattern for a single panel with main lobe 302a and first side-lobe 302b. FIG. 3A includes a plot 304 of an antenna pattern for a six-panel antenna with main lobe 304a and first side-lobe 304b.

FIG. 3B is a graph 300b illustrating an example antenna pattern for a six-panel antenna at a steering angle of 0.3°. FIG. 3B includes a plot 302 of an antenna pattern for a single panel with main lobe 302a and first side-lobe 302b. FIG. 3B includes a plot 304 of an antenna pattern for a six-panel antenna with main lobe 304a and first side-lobe 304b. Plot 304 includes a grating side-lobe 304c (only one grating side-lobe called out in FIG. 3B). Grating side-lobe 304c is less significant relative to main lobe 204a at a steering angle of 0.3° than grating side-lobe 204c relative to main lobe 204a of FIG. 2B. For example, in plot 300b, grating side-lobe 304c is approximately 13 dB below main lobe 204a. Grating side-lobe 304c has less adverse effect on image quality than grating side-lobe 204c.

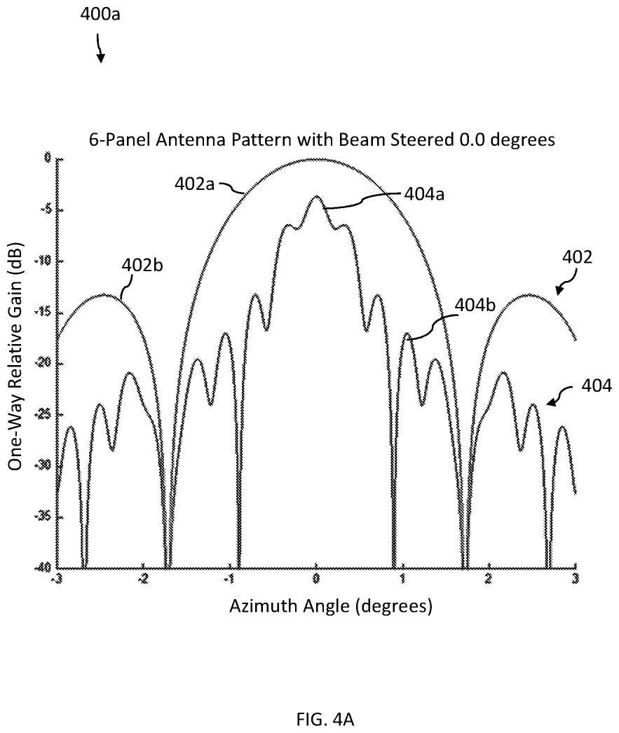

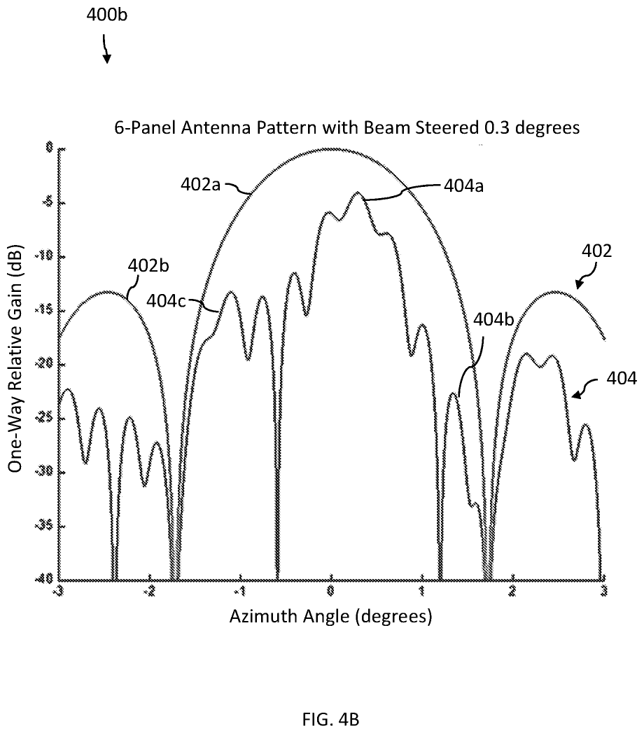

FIG. 4A is a graph 400a illustrating an example antenna pattern for a six-panel antenna with beam-spoiling at a steering angle of 0°. In the example of FIG. 4A, the beam-spoiling phase coefficients for panels n=1 to n=6 are set to values 0°, 80°, 120°, 120°, 80°, and 0°, respectively. In other examples, the beam-spoiling coefficients can be set to other values. FIG. 4A includes a plot 402 of an antenna pattern for a single panel with main lobe 402a and first side-lobe 402b. FIG. 4A includes a plot 404 of an antenna pattern for a six-panel antenna with main lobe 404a and first side-lobe 404b.

FIG. 4B is a graph 400b illustrating an example antenna pattern for a six-panel antenna with beam-spoiling at a steering angle of 0.3°. As in FIG. 4A, the beam-spoiling phase coefficients for panels n=1 to n=6 are set to values 0°, 80°, 120°, 120°, 80°, and 0°, respectively. FIG. 4B includes a plot 402 of an antenna pattern for a single panel with main lobe 402a and first side-lobe 402b. FIG. 4B includes a plot 404 of an antenna pattern for a six-panel antenna with main lobe 404a and first side-lobe 404b. Plot 404 includes a grating side-lobe 404c (only one grating side-lobe called out in FIG. 4B). Grating side-lobe 404c is more significant relative to main lobe 404a at a steering angle of 0.3° than grating side-lobe 304c relative to main lobe 304a of FIG. 3B. For example, in plot 400b, grating side-lobe 404c is approximately 10 dB below main lobe 404a. Grating side-lobe 404c can have more adverse effect on image quality than grating side-lobe 404c.

### Signal Processing

The phase history of a point target illuminated by an antenna beam can be approximated by a quadratic function of time. The range to the point target at an along-track location Xₙ (using a simplified 2D model) as a function of time t can be given by:

R(t)=\sqrt{R₀²+(Xₙ+V*t)^{t}}

where R₀ is the range to the target at time t=0, the time at which target is at broadside (relative to the ground track of the SAR), and V is the velocity of the SAR platform.

A phase correction to focus the point target can be given by:

$$F ( t ) = {e}^{- i * 2 * π * ( \frac{2 * R ( t )}{λ} )}$$

A focusing operation for position Xₙ, producing processing output Pₙ as the result, can be represented as follows:

$${P}_{n} = {\sum }_{m} {S}_{m} * {W}_{m} * F ( {t}_{m} )$$

where Sₘ is the complex signal received in the m^{th} PRI, tₘ is the time of the m^{th} PRI, and Wₘ is an amplitude weighting selected to produce a desired level of signal-processing side-lobes.

Weighting Wₘ can correct for aspects of an antenna beam pattern, and/or applies an amplitude weighting after the antenna beam pattern has been corrected.

$${W}_{m} = \frac{{K}_{m}}{{TX}_{m} * {RX}_{m}}$$

where Kₘ is a processor weighting for a desired level of signal-processing side-lobes. A typical value is Kₘ=2.9. TXₘ and RXₘ are amplitude responses of the transmit and the receive antennas, respectively, across the processing aperture.

Though, in some implementations, the amplitude response of the transmit and the receive antennas be the same, it is more typical for the amplitude responses to be different. Applying beam-spoiling on transmit can produce a response containing large ripples (see for example FIGS. 4A and 4B). The ripples can result in paired echo sidelobes if uncorrected.

### Implementation Alternatives

There are various alternatives for implementing Spotlight imaging mode in a SAR. An expected performance of the implementation alternatives can be estimated using simulations. In one example simulation, targets are equally spaced, and the array spans several antenna beam widths. A portion of the targets are within the desired along-track swath, and the results from these targets can be used to measure image quality metrics such as Impulse Response Width (IRW), Integrated Sidelobe Ratio (ISLR), Peak Sidelobe Ratio (PSLR), and to estimate Noise Equivalent Sigma Zero (NESZ). As described above, a typical value of Kₘ=2.9 can be used. In the present example, the IRW for the simulated scenario is expected to 1 m. The ISLR is expected to be −21 dB, and the PSLR is expected to be −23.5 dB.

Some targets are outside the desired along-track swath, and can be used to show azimuth ambiguities resulting from the antenna grating lobes. These targets can be processed separately to measure an azimuth ambiguity ratio (AMBR), and to distinguish their impulse responses in an easily distinguishable way.

Pencil Beam: In one implementation, the antenna beam is a “pencil beam” i.e., has no spoiling applied to the antenna pattern on either transmit or receive. Some targets can be focused targets within the Spotlight image. In an example scenario, the along-track swath width can be 3.5 km. Other targets can be outside the Spotlight image, and can be received through the extremities of the antenna beam, and through the antenna sidelobes (including grating lobes). These targets show up as azimuth ambiguities. In one example scenario, the measured ambiguity ratio is −29 dB for a selected PRF of 5 kHz.

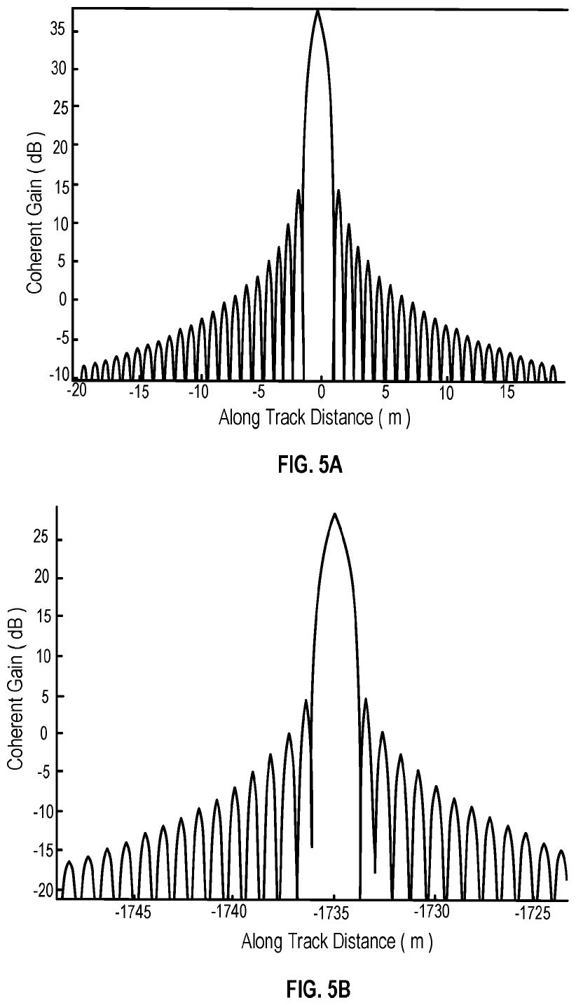

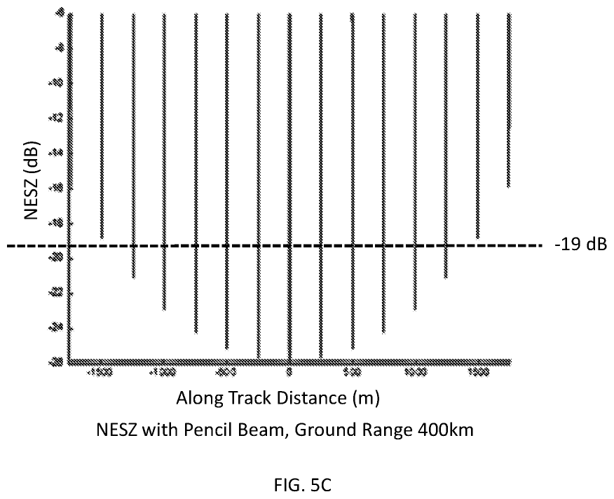

FIGS. 5A and 5B show the impulse responses for point targets at the center and the edge of the swath, respectively. The image quality is as expected for the selected Kaiser weighting i.e. IRW, ISLR and PSLR are as expected for all locations across the swath.

The along-track extent of the Spotlight image can be determined at least in part by the product of the angular extent of the antenna azimuth beam and the range to the target. FIG. 5C shows an estimated NESZ across the swath. The scenario illustrated is a ground range of approximately 400 km (approximately 600 km in slant range).

The NESZ at the swath center is −26 dB. At the edge of the swath, the NESZ is −16 dB. If a useable NESZ is defined as being better than −19 dB (as indicated by the dashed line), then the pencil beam approach can support a swath width of approximately 3 km.

The estimated NESZ at a ground range of 290 km (approximately 535 km in slant range) can be improved over the scenario of FIG. 5C at the center of the swath, and is the same or similar as the edge of the swath. The estimated NESZ at a ground range of 135 km (approximately 470 km in slant range) can show the same, or at least similar, effects.

### Spoiled Beam:

In another implementation, an antenna beam is a spoiled beam. A spoiled beam is a beam that has been intentionally broadened. Spoiling can be applied to the antenna pattern on transmit, on receive, or on both transmit and receive. An objective of using a spoiled beam is to achieve a wider swath width, for example to increase the along-track swath width from 3 km to 5 km.

An antenna beam can be spoiled by applying phase shifts to the antenna panels, as described above. Examples for a six-panel antenna include the following (in degrees, one value for each of the six panels):

Case 1: [0, 60, 90, 90, 60, 0]

Case 2: [0, 80, 120, 120, 80, 0]

Case 3: [0, 120, 140, 140, 120, 0]

In the scenario of Case 1, the two-way antenna gain at the beam center can be reduced by approximately 4 dB as a result of the beam-spoiling, and the NESZ can be reduced similarly from −26 dB to −22 dB. At the edge of the swath, the broadening of the beam may not compensate adequately for the loss of gain, and the swath width (defined as NESZ better than −19 dB) may be reduced to 2 km. In addition, the azimuth ambiguities can be worse.

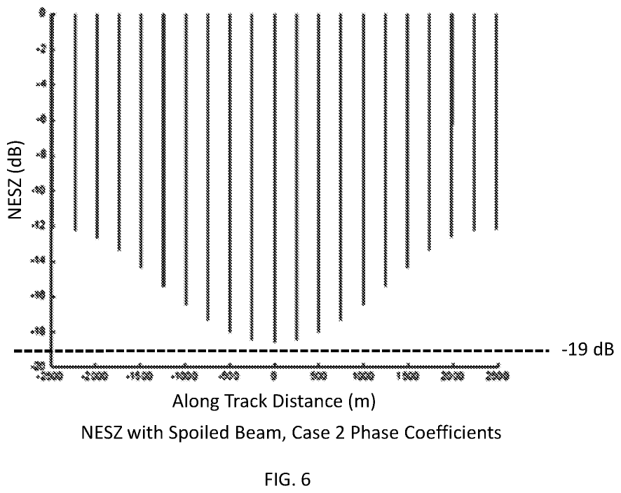

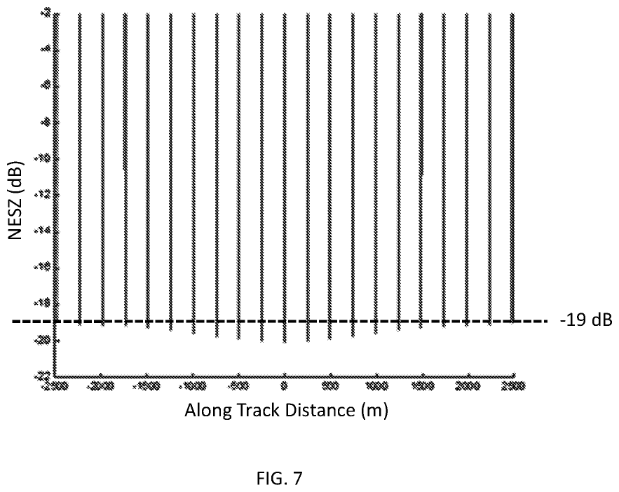

FIG. 6 is a plot of estimated NESZ for Case 2 above, at the 400 km range. The plot shows that the two-way antenna gain at the beam centre can be reduced by 8 dB, and the NESZ similarly reduced (compared to FIG. 5C) from −26 dB to −18 dB. An NESZ of −19 dB is not achieved anywhere within the swath for the scenario illustrated in FIG. 6. Case 3 can be worse in terms of NESZ performance.

As described above in reference to FIGS. 5A, 5B, 5C, and 6, spoiling an antenna beam can be a high-loss operation, and a shortcoming of applying beam-spoiling techniques on both transmit and receive is that it can lead to undesirable performance, for example as measured by NESZ.

### Multiple Receive Beams:

Systems and methods described in the present application use a spoiled beam on transmit, and, at the same time, use multiple apertures on receive. A benefit of using multiple apertures on receive is that losses and/or degradation of image quality can be eliminated, or at least reduced, on the receive side, thereby mitigating, at least to some degree, losses and/or degradation of image quality incurred by attempting to broaden the swath.

Reducing aperture size can be another way to broaden the antenna beam. If the antenna physical aperture is sub-divided into M sub-apertures, the beam pattern of each sub-aperture pattern can be broadened by a factor of M compared to the pencil beam described above (M=1). The gain of the sub-aperture can be reduced by the same factor M. If the data from each sub-aperture is processed into a separate image (yielding M images of the same scene), then the separate images can be combined coherently to recover a factor of M in NESZ. The loss incurred on the receive side from broadening the receive beam by the factor M can be eliminated, or at least reduced. A consequence of using multi-aperture receive beams is an increase in a data rate and processing load which in some scenarios can be increased by the factor M.

Each receive sub-aperture (i.e., azimuth aperture comprising one or more azimuth phase centers) can be steered independently to point at a desired location in the scene. The phase of each phase center can be offset relative to the others by applying a phase function across the phase centers comprising the sub-aperture. For example, the phase function can be a linear phase ramp. As described above in reference to electronic beam steering, the phase offset (φₙ) of a given phase center to steer the beam to angle θ can be given by:

$${ϕ}_{n} = \frac{{a}_{n} * sin θ}{λ}$$

where aₙ=(n−0.5*(N+1))*A, A is the horizontal dimension of the antenna associated with the given phase center, N is the number of phase centers (N=6 in this case), λ is the wavelength, and n is an integer index assigned to each phase centers (1≤n≤6 in this case).

Receive antenna configurations for a six-phase-center antenna may include:
M=1, N=6
M=2, N=3
M=3, N=2

Processing of the SAR data can be modified to take into account the offset locations of the receive sub-apertures. As described above, the range to the point target for the transmit antenna, at along-track location Xₙ (using a simplified 2D model) as a function of time t can be given by:

R(t)=\sqrt{R₀²+(Xₙ+V*t)²}

where R₀ is the range to the target at time t=0, the time at which target is at broadside, and V is the velocity of the platform.

The range to the point target for receive sub-aperture m is given by:

R_{RX}(t)=\sqrt{R₀²+(Xₙ+bₘ+V*t)²}

where bₘ=(m−0.5*(M+1))*A*N .

A phase correction to focus the point target can be given by:

$$F ( t ) = {e}^{- i * 2 * π * ( \frac{{R}_{TX} + {R}_{RX}}{λ} )}$$

The image for each sub-aperture (also referred to in the present application as a sub-image) can be formed by applying these modified equations within the previously presented image formation process. The final image can formed by coherently summing the images formed from each of the sub-apertures.

An additional phase correction can be applied to the focused image for each pixel n, as follows:

$${R}_{n} = \sqrt{{R}_{0}^{2} + {( {X}_{n} )}^{2}}$$

$${ϕ}_{n} = {e}^{i * 2 * π * ( \frac{2 * {R}_{n}}{λ} )}$$

The additional correction can be used to produce a zoomed image via zero padding.

It can be shown, by simulation for example, that the NESZ can be reduced to −22 dB from −18 dB at the swath center when Case 2 spoiling is applied to the transmit beam and a pencil beam (single aperture) receive beam is used. At 2.5 km from the swath center, however, the NESZ has degraded to −6 dB, compared to −12 dB in a previously described scenario.

Though the loss from spoiling can be cut in half from 8 dB to 4 dB, the two-way beam can still be undesirably narrow. Dividing the receive antenna into two sub-apertures can increase the receive beamwidth by a factor of two. The NESZ at the swath center remains essentially the same. At 2.5 km from the swath center, the NESZ can be improved to −16 dB, a 10 dB improvement compared to a previously described scenario. Dividing the receive antenna into three sub-apertures can further improve the NESZ at 2.5 km from the swath center.

FIG. 7 is a plot showing an estimated NESZ across a Spotlight swath for transmit spoiling and multiple sub-apertures on receive. FIG. 7 uses additional spoiling on the transmit beam (Case 3), and 3 sub-apertures on receive. The NESZ at the swath center is −20 dB, and at 2.5 km from the swath center, the estimated NESZ has improved to −19 dB. For this example, the desired NESZ value of −19 dB can be achieved across the 5 km swath.

By processing the images, it can be shown that the desired values of image quality metrics IRW, ISLR, and PSLR can be achieved, which indicates that the antenna beam pattern corrections are removing, or at least reducing, amplitude ripples caused by beam spoiling.

### Azimuth Ambiguities

Using multiple receive aperture techniques, such as those described above, can affect azimuth ambiguity performance. The ambiguity ratio is defined as the power of unwanted targets divided by the power of wanted targets, integrated over the swath.

The objective of the multiple receive aperture approach is to broaden the antenna beam, to achieve a wider along-track swath width. Generally, a broader antenna beam can lead to a higher level of azimuth ambiguities for a given Pulse Repetition Frequency (PRF). In one implementation, the PRF is 16 kHz.

The sidelobes can increase relative to the main lobe of the IRW in a Spotlight image formed using a spoiled transmit beam and a single aperture (pencil) receive beam. In some scenarios, for example when an image is formed using a spoiled transmit beam and two 3-panel receive beams, the sidelobes can be absorbed into a broad main lobe.

The PRF can be adjusted within constraints imposed by a desired swath width. For example, the PRF can be reduced to 4 kHz.

In some scenarios, azimuth ambiguities can be cancelled, or at least mitigated, by the signal processing, and azimuth ambiguity performance can be improved by as much as 13 dB.

There can be a trade-off between PRF and azimuth ambiguities. Simulation results indicate that a PRF of 8 kHz can produce adequate performance with respect to azimuth ambiguity, for the given antenna configuration of case 3 transmit beam spoiling (see above), and three receive sub-apertures.

### Range Ambiguities

Range ambiguities can be affected by the various approaches described above. Simulations of various scenarios indicate that a PRF selected to be in the range 8 kHz to 9 kHz can provide acceptable performance for both range and azimuth ambiguities.

### Data Rates and BAQ

As described above, use of multi-aperture techniques can increase the data rate for Spotlight imaging mode. Data compression can be used to mitigate the increased data rate. An example of a data compression technique is Block Adaptive Quantization (BAQ). Data compression can adversely affect image quality.

In some implementations, an acceptable data rate can be constrained by the data rate across one or more interfaces in the SAR.

The data rate BPS can be estimated as follows:

$${S}_{PRI} = ( \frac{2 * ( {R}_{2} - {R}_{1} )}{C} + \frac{D C}{PRF} ) * SR * M$$

$$BPS = {S}_{PRI} * PRF * \frac{NBAQ}{8} * 2$$

where R₁ and R₂ are a slant range to a start and an end of a swath respectively, assuming a ground range swath of 10 km, DC is a transmit duty cycle, PRF is the pulse repetition frequency, SR is the sample rate, M is the number of receive sub-apertures, SPRI is the number of data samples (I/Q pairs) per PRI, NBAQ is the number of bits (for each of I and Q) output by the BAQ compression algorithm, and BPS is the number of bytes per second.

BPS can depend at least in part on NBAQ and the number of receive sub-apertures. There is a trade-off between data rate and image quality. Increasing the level of data compression can reduce data rate at the expense of image quality.

Simulations can show that for two receive sub-apertures, 4-bit BAQ can be used, and for three sub-apertures, 3-bit BAQ can be used with acceptable impact on image quality for data rates achievable by a typical SAR such as described above.

### Interpolated and Combined Data Streams

In another approach to forming a SpotSAR image, a method employed in the context of Stripmap SAR can be used. Data received by the six sub-apertures can be interpolated to a common time point, and then combined by summation within the spacecraft. Summation can be a coherent summation.

The interpolation operation can replace the receive beam steering, and the receive antenna pattern becomes that of a single antenna panel. The transmit beam can be spoiled and steered as before. In comparison to the data rates described above, the data rate for this approach can be 0.54 GBs as there is now only a single data stream to download.

The image quality can generally be good at the centre of the swath as a StripSAR processing method is better suited to that condition. A Stripmap SAR processing method is one that is suited to processing of Stripmap SAR data. Image quality performance can be degraded at the edge of the swath, relative to the center of the swath.

### Space-Time Combination of Data Streams

In yet another approach to forming a SpotSAR image, another method employed in the context of Stripmap SAR can be used. Data received by the six sub-apertures can be combined by space-time combination of data streams. In one implementation, data is combined by processing on the ground. The approach can use a PRF as low as 2.4 kHz for example. Space-time combination can remove, or at least reduce, the need for the receive beam steering. The transmit beam can be spoiled and steered as before. For scenarios comparable to those described above, the data rate can be 1.94 GBs as there now six data streams to download, and data compression can be necessary, or at least advantageous. For example, BAQ compression to 3 bits can be used to compress the data.

The image quality can generally be good at the centre of the swath as the StripSAR algorithm is better suited to that condition. Image quality performance can be degraded at the edge of the swath, relative to the center of the swath.

### Performance

Systems and methods described in the present application can enhance the performance of a SAR operating in a Spotlight imaging mode, and include multi-aperture beam steering, and data processing.

For operational purposes, it can be desirable to have an along-track image swath of 5 km in a Spotlight imaging mode and a resolution of at least 1 m. Previous approaches have placed limits on swath width, for example with an operating as a pencil beam to a swath width of approximately 3 km.

Systems and methods described in the present application can achieve a 5 km swath for the example dual-band antenna implementation described above. The approach described in the present application uses beam-spoiling and multi-aperture data processing to deliver the desired swath width while meeting desired image quality such as NESZ.

The multi-aperture technique described above can cancel azimuth ambiguities, or at least limit the effect of azimuth ambiguities, and can yield up to an approximately 13 dB improvement in performance in some cases.

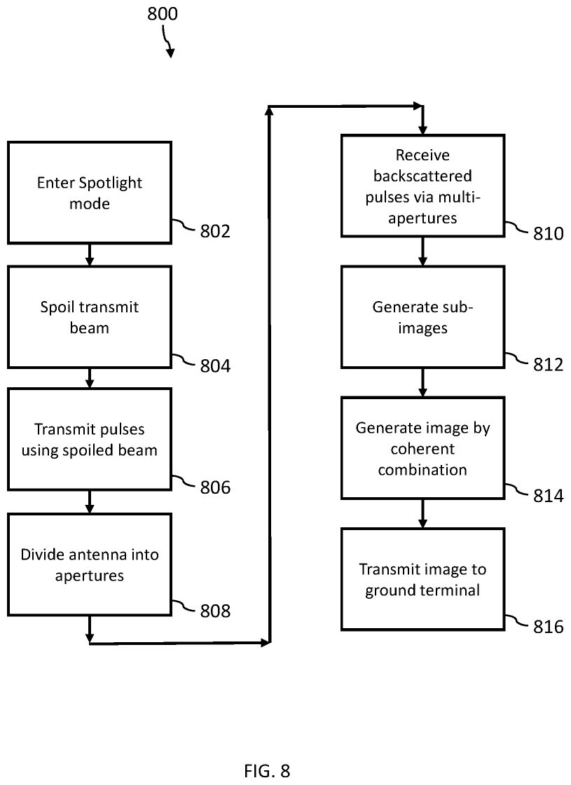

FIG. 8 is a flow chart illustrating an example implementation of a method 800 for multi-aperture Spotlight mode operation of a SAR, in accordance with the systems and methods described in the present application.

At 802, the SAR controller causes the SAR to enter a Spotlight SAR imaging mode, for example in response to a command. At 804, the SAR spoils a transmit beam of the SAR antenna to form a spoiled transmit beam. At 806, the SAR transmits a plurality of transmitted pulses by the SAR antenna using the spoiled transmit beam. At 808, the SAR controller divides the SAR antenna into a plurality of apertures. At 810, the SAR antenna receives a plurality of backscattered pulses by the SAR using a number M of multiple receive beams. At 812, the SAR processor processes data received by each of the number M of multiple receive beams to generate a number M of sub-images. At 814, the SAR coherently combine two or more of the number M of sub-images to form a Spotlight image. At 816, the SAR optionally downlinks the Spotlight image via a communications antenna to a ground terminal.

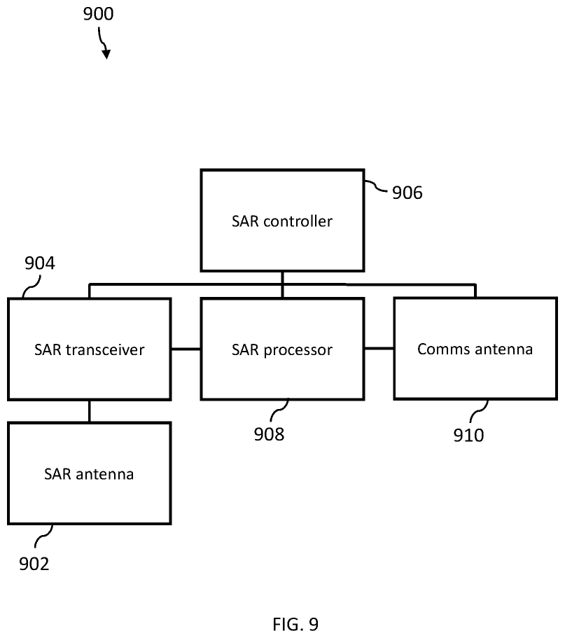

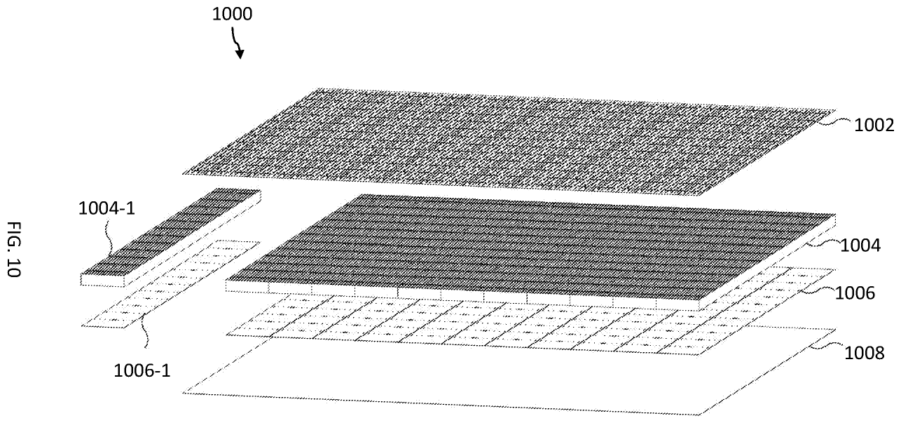

FIG. 9 is a block diagram of a SAR system 900, in accordance with the systems and methods of the present application. SAR system 900 can be a multi-band SAR system, for example a dual-band XL SAR system. SAR system 900 can be on-board a SAR platform such as an aircraft or spacecraft. SAR system 900 comprises a SAR antenna 902, a SAR transceiver 904, a SAR controller 906, a SAR processor 908, and a communications antenna 910.

SAR antenna 902 can be a shared aperture antenna. SAR antenna 902 can be a planar phased array such as described in International Patent Application Publication WO 2017/044168 entitled “EFFICIENT PLANAR PHASED ARRAY ANTENNA ASSEMBLY”, for example. SAR antenna 902 is communicatively coupled to transceiver 904. SAR transceiver 904 can transmit and receive pulses at one or more frequency bands, for example at X-band and L-band. SAR transceiver 904 can transmit and receive pulses for two or more frequency bands at the same time. For example, SAR transceiver 904 can transmit and receive L-band pulses for wide-swath SAR imaging and X-band pulses for high-resolution imaging at the same time (i.e., in the same acquisition window). The pulses can be synchronized with each other. The SAR antenna can transmit and receive pulses for one or more imaging modes such as ScanSAR mode and strip-map mode. SAR transceiver 504 can transmit and receive pulses in one or more beams, and in one or more sub-beams.

In some implementations, transceiver 504 comprises a separate transmitter and receiver. In some implementations, transceiver 504 comprises one or more transmit/receive (TR) modules.

SAR controller 906 can comprise one or more processors. SAR controller 906 can include at least one of a Field-Programmable Gate Array (FPGA), an Application Specific Integrated Circuit (ASIC), a microcontroller, and a microprocessor, and one or more programs or firmware stored on one or more nontransitory computer- or processor-readable media.

SAR processor 908 can process SAR acquired by SAR antenna 902 and SAR transceiver 904. SAR processor 908 can process data in near-real-time. SAR processor 908 can perform range compression, azimuth compression, target detection and identification, chip extraction, velocity estimation, and/or image classification. SAR processor 908 can process data for one or more imaging modes of SAR system 900, for example SAR processor 908 can process wide-swath ScanSAR or strip-map mode data, and can process high-resolution strip-map or Spotlight mode data.

Communications antenna 910 can transmit and receive data, for example communications antenna 910 can transmit acquired SAR data, processed SAR targets, target detections, identifications, and image classifications from SAR system 900 to a ground terminal. Communications antenna 910 can receive commands and/or ancillary data from a ground terminal. The ground terminal (not shown in FIG. 9) can include a communications antenna and a transceiver.

FIG. 10 shows a SAR antenna in the form of a planar phased array antenna assembly 1000. The size of planar phased array antenna assembly 1000 can be tailored to meet the gain and bandwidth requirements of a particular application. An example application is a dual-band, dual-polarization SAR antenna. In an example implementation of a dual-band, dual-polarization SAR antenna, planar phased array antenna assembly 1000 is approximately 2.15 m wide, 1.55 m long and 50 mm deep, and weighs approximately 30 kg. In another implementation, planar phase array antenna assembly 1000 comprises a single panel of dimensions 6 m by 2 m. In yet another implementation, planar phased array antenna assembly 1000 comprises six panels, each panel of dimensions 1 m by 2 m.

Planar phased array antenna assembly 1000 is an example of a dual-band (X-band and L-band), dual-polarization (H and V polarizations at L-band) SAR antenna assembly. While embodiments described in this document relate to dual X-band and L-band SAR antennas, and the technology is particularly suitable for space-based SAR antennas for reasons described elsewhere in this document, a similar approach can also be adopted for other frequencies, polarizations, configurations, and applications including, but not limited to, single-band and multi-band SAR antennas at different frequencies, microwave and mm-wave communication antennas, and airborne and spaceborne SAR antennas.

Planar phased array antenna assembly 1000 comprises a first face sheet 1002 on a top surface of planar phased array antenna assembly 1000, containing slots for radiating elements which, in the example implementation of FIG. 10, are L-band and X-band radiating elements. Planar phased array antenna assembly 1000 comprises microwave structure 1004 below first face sheet 1002. Microwave structure 1004 comprises one or more subarrays such as subarray 1004-1, each subarray comprising radiating elements, which, in the example implementation of FIG. 10, are L-band and X-band radiating elements.

Microwave structure 1004 can be a metal structure that is self-supporting without a separate structural subassembly. Microwave structure 1004 can be machined or fabricated from one or more metal blocks, such as aluminium blocks or blocks of another suitable conductive material. The choice of material for microwave structure 1004 determines, at least in part, the losses and therefore the efficiency of the antenna.

Planar phased array antenna assembly 1000 comprises second face sheet 1006 below microwave structure 1004, second face sheet 1006 closing one or more L-band cavities at the back. Second face sheet 1006 comprises one or more sub-array face sheets such as 1006-1.

Planar phased array antenna assembly 1000 comprises third face sheet 1008 below second face sheet 1006, third face sheet 1008 comprising waveguide terminations. Third face sheet 1008 also provides at least partial structural support for antenna assembly 1000.

In some implementations, planar phased array antenna assembly 1000 comprises a multi-layer printed circuit board (PCB) (not shown in FIG. 10) below third face sheet 1008, the PCB housing a corporate feed network for the X-band and L-band radiating elements.

The various embodiments described above can be combined to provide further embodiments. The contents of provisional application U.S. Ser. No. 62/510,182, filed on May 23, 2017 entitled “APPARATUS AND METHODS FOR A SYNTHETIC APERTURE RADAR WITH MULTI-APERTURE ANTENNA” and listing as inventors Peter Fox and Stephen Lilley; the contents of International Patent Application Publication WO 2017/044168 entitled “EFFICIENT PLANAR PHASED ARRAY ANTENNA ASSEMBLY”, and contents of provisional application U.S. Ser. No. 62/510,191 entitled “SYNTHETIC APERTURE RADAR IMAGING APPARATUS AND METHODS FOR MOVING TARGETS” are each incorporated herein by reference in their entirety. Aspects of the embodiments can be modified, if necessary, to employ systems, circuits and concepts of the various patents, applications and publications to provide yet further embodiments.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

While particular elements, embodiments and applications of the present technology have been shown and described, it will be understood, that the technology is not limited thereto since modifications can be made by those skilled in the art without departing from the scope of the present disclosure, particularly in light of the foregoing teachings.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation of a synthetic aperture radar (SAR) system comprising a SAR antenna, a SAR processor, and a SAR controller, the method comprising:
entering a Spotlight SAR imaging mode by the SAR controller;
spoiling a transmit beam of the SAR antenna to form a spoiled transmit beam;
transmitting a plurality of transmitted pulses by the SAR antenna using the spoiled transmit beam;
dividing the SAR antenna into a plurality of azimuth apertures by the SAR controller;
receiving a plurality of backscattered pulses by the SAR antenna using a number M of multiple receive beams, each of the plurality of backscattered pulses corresponding to a respective one of the plurality of transmitted pulses;
processing data received by each of the number M of multiple receive beams to generate a number M of sub-images by the SAR processor; and
coherently combining two or more of the number M of sub-images to form a Spotlight image.

2. The method of claim 1 further comprising:
compressing data from the number M of multiple receive beams by the SAR processor.

3. The method of claim 2 wherein compressing data from the number M of multiple receive beams by the SAR processor includes performing a Block Adaptive Quantization (BAQ) to 4 bits.

4. The method of claim 1 wherein receiving a plurality of received pulses by the SAR antenna using a number M of multiple receive beams includes receiving a plurality of received pulses by a planar phased array.

5. The method of claim 4 wherein receiving a plurality of received pulses by a planar phased array includes receiving a plurality of received pulses by a planar phase array comprising a plurality of antenna phase centers.

6. The method of claim 1 wherein receiving a plurality of received pulses by the SAR antenna using a number M of multiple receive beams includes receiving a plurality of received pulses by a dual-band antenna.

7. The method of claim 6 wherein receiving a plurality of received pulses by a dual-band antenna includes receiving a plurality of received pulses by at least one of an X-band or an L-band antenna.

8. The method of claim 1 wherein processing data received by each of the number M of multiple receive beams to generate a number M of sub-images by the SAR processor includes processing data received by each of the number M of multiple receive beams to generate a number M of sub-images by the SAR processor on-board one of a satellite, a spacecraft, and a space station.

9. The method of claim 8 further comprising:
downlinking one or more of the number M of sub-images by a communications antenna to a ground terminal.

10. The method of claim 8 wherein coherently combining two or more of the number M of sub-images to form a Spotlight image includes coherently combining two or more of the number M of sub-images to form a Spotlight image on-board one of a satellite, a spacecraft, and a space station.

11. The method of claim 10 further comprising:
downlinking the Spotlight image by a communications antenna to a ground terminal.

12. The method of claim 1 wherein spoiling a transmit beam of the SAR antenna to form a spoiled transmit beam includes broadening a transmit beam of the SAR antenna to form a spoiled transmit beam.

13. The method of claim 1 wherein spoiling a transmit beam of the SAR antenna to form a spoiled transmit beam includes applying a phase shift to an antenna panel of the SAR antenna.

14. A method of operation of a synthetic aperture radar (SAR) system comprising a SAR antenna, a SAR processor, and a SAR controller, the method comprising:
entering a Spotlight SAR imaging mode by the SAR controller;
transmitting a plurality of transmitted pulses by the SAR antenna using a transmit beam;
dividing the SAR antenna into a plurality of azimuth apertures by the SAR controller;
spoiling a number M of multiple receive beams;
receiving a plurality of backscattered pulses by the SAR antenna using the number M of multiple receive beams, each of the plurality of backscattered pulses corresponding to a respective one of the plurality of transmitted pulses;
processing data received by each of the number M of multiple receive beams to generate a number M of sub-images by the SAR processor; and
coherently combining two or more of the number M of sub-images to form a Spotlight image.

15. A SAR system comprising:
a SAR antenna;
a SAR processor;
a communications antenna; and
a SAR controller to:
place the SAR system in a Spotlight SAR imaging mode;
spoil a transmit beam of the SAR antenna to form a spoiled transmit beam;
transmit a plurality of transmitted pulses by the SAR antenna using the spoiled transmit beam;
divide the SAR antenna into a plurality of azimuth apertures;
receive a plurality of backscattered pulses by the SAR antenna using a number M of multiple receive beams, each of the plurality of backscattered pulses corresponding to a respective one of the plurality of transmitted pulses;
process data received by each of the number M of multiple receive beams to generate a number M of sub-images by the SAR processor; and
coherently combine two or more of the number M of sub-images to form a Spotlight image.

16. The SAR system of claim 15 wherein the SAR antenna is a spaceborne SAR antenna.

17. The SAR system of claim 15 wherein the SAR processor and the SAR controller are co-hosted with the spaceborne SAR antenna on one of a satellite, a spacecraft, and a space station.

18. The SAR system of claim 15 wherein the SAR antenna comprises a plurality of antenna panels, the SAR system operable to apply to each of the plurality of antenna panels a respective phase shift, the respective phase shift selected to cause a broadening of a beam of the SAR antenna.
